(19) United States
(12) Patent Application Publication
(10) Pub. No.: US 2010/0057546 A1
(43) Pub. Date: Mar. 4, 2010

(54) SYSTEM AND METHOD FOR ONLINE ADVERTISING USING USER SOCIAL INFORMATION

(75) Inventors: Yang Wang, Union City, CA (US); John Langford, White Plains, NY (US); Jianbin Wei, Menlo Park, CA (US)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/202,246

(22) Filed: Aug. 30, 2008

(51) Int. Cl. G06Q 30/00

(52) U.S. Cl. 705/14.4

(57) ABSTRACT

An improved system and method for online advertising using user social information is provided. An advertising demand engine may be provided for selecting advertisements using user social information and online behavior to serve to a user for display. A social network engine may be provided for constructing a plurality of networks of correlated users from social network information and online behavior. These networks may be updated with additional online behavior. An advertisement previously selected by a user or by other users belonging to a network constructed using social information and online behavior may be sent to users belonging to the same network in response to a request to serve an advertisement. In other embodiments, a ranked list of advertisements selected by users in multiple networks may be determined, and advertisements may then be sent to users from the ranked list of advertisements.

### FIELD OF THE INVENTION

The invention relates generally to computer systems, and more particularly to an improved system and method for online advertising using user social information.

### BACKGROUND OF THE INVENTION

Traditionally, there are two internet advertising market segments. One is text advertisement segment, and the other is banner segment. Text advertisements business is mainly conducted through sponsored search auction and content match technologies. Sponsored search auctions are a widely used mechanism for selling online advertisements using Internet search engines. Each time a user enters a search term into a search engine, a sponsored search auction allocates the advertising space within that user's search results. There are hundreds of millions of separate online sponsored search auctions conducted every day. Content matching is also a widely used mechanism for selling online advertising by matching advertisements to content published on the Internet. Each time a user requests published content, advertising space may be allocated within the content served in response to the user's request.

For instance, in online search advertising, keywords of a user's query may be auctioned to an advertiser who is the highest bidder with sufficient budget. In content matching, page content may be aggregated into keywords, and advertisements may be match to content using the highest payment offered by an advertiser for the keywords representing the content.

For banner advertising segment, behavioral targeting technology has been used, where both users and advertisements are mapped into categories, and then advertisements that are in the same categories with a user will be served to that user. Unfortunately, the categories may be defined by marketing personnel relying on their experience, rather than by the experience and social interests of the users. Moreover, the categories may be defined in a hierarchy that may focus on vertical areas such as travel or shopping, and thus may unnecessarily restrict selection of an advertisement within a vertical, instead of considering the broader interests of the users.

What is needed is a way to provide advertisements that are more relevant to users' interest. Such a system and method should consider users' experience and social interests to provide more relevant advertisements.

### SUMMARY OF THE INVENTION

The present invention provides a system and method for online advertising using user social information. An advertising demand engine may be provided for selecting advertisements using user social information and online behavior to be served to a user for display. In general, an advertisement previously selected by a user or by other users belonging to a network constructed using social information and online behavior may be sent to users belonging to the same network in response to a request to serve an advertisement. An advertisement correlation engine may be provided for correlating one advertisement to another advertisement or clustering correlated advertisements, and a social network engine may be provided for constructing a plurality of networks of correlated users from social network information and online behavior to serve the one or more advertisements to users for display in online advertising.

To serve advertisements using user social information and online behavior, multiple networks that represent the relationship of users may be constructed from social information and online behavior, and these networks may be updated with additional online behavior. In an embodiment for applying user social information to serve an advertisement to other users in online advertising, a request to serve a first advertisement to a first user belonging to a network constructed from social information and online behavior of a plurality of users may be received, and a first advertisement may be sent to the first user. The first user may click on the first advertisement and the network may be updated with the event that the first user clicked on the first advertisement. A request to serve a second advertisement to a second user belonging to the same network constructed from social information and online behavior of a plurality of users may be received. The network may be searched to find an advertisement clicked-on by a user, and the first advertisement clicked-on by the first user may be sent to the second user.

In another embodiment for applying user social information to serve multiple advertisements to a user in online advertising, a request may be received to serve a first advertisement to a first user belonging to a network constructed from social information and online behavior of a plurality of users. A list of advertisements selected by users in the network may be determined, and the list of advertisement may be ranked for instance in order by score of weighted edges in the network connecting the users to the first user. One or more of the advertisement may then be sent to the first user from the ranked list of advertisements.

In yet another embodiment, a request may be received to serve a first advertisement to a first user belonging to multiple networks constructed from social information and online behavior of a plurality of users. A list of advertisements selected by users in the multiple networks may be determined, and the list of advertisement may be ranked for instance in order by score of weighted edges in the multiple networks connecting the users to the first user. One or more of the advertisement may then be sent to the first user from the ranked list of advertisements. One or more advertisements may then be served to a second user from the ranked list of advertisements in response to a request to serve a second advertisement to a second user belonging to multiple networks constructed from social information and online behavior of a plurality of users.

The present invention may support many applications for online advertising using user social information. For example, online search advertising applications may use the present invention to select a list of advertisements using user social information for web page placements displayed with query results for a user. Or online content applications may use the present invention to select a list of advertisements using user social information for web page placements displayed with content requested by a user. Similarly, email applications may use the present invention to select a list of advertisements using user social information to be displayed with a message from an inbox requested by a user, or ecommerce applications may use the present invention to select a list of advertisements using user social information to be displayed with product information requested by a user. For any of these online applications, a list of advertisements may be selected by the present invention using user social information for display to a user.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for online advertising using user social information, in accordance with an aspect of the present invention;

FIG. 3 is a flowchart generally representing the steps undertaken in one embodiment for constructing multiple networks representing the relationship of users from social network information and online behavior, in accordance with an aspect of the present invention;

FIG. 4 is a flowchart generally representing the steps undertaken in one embodiment for applying user social information to serve an advertisement to other users in online advertising, in accordance with an aspect of the present invention;

FIG. 5 is a flowchart generally representing the steps undertaken in one embodiment for applying user social information to serve multiple advertisements to a user in online advertising, in accordance with an aspect of the present invention; and

FIG. 6 is a flowchart generally representing the steps undertaken in one embodiment for applying user social information to serve multiple advertisements to multiple users in online advertising, in accordance with an aspect of the present invention.

### DETAILED DESCRIPTION

### Exemplary Operating Environment

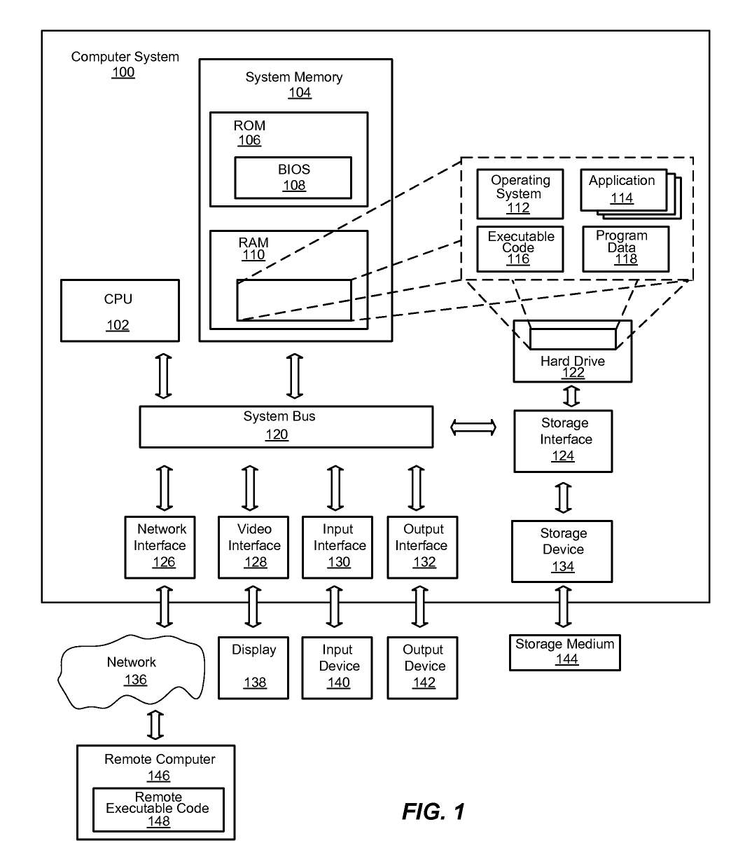

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

### Online Advertising Using User Social Information

The present invention is generally directed towards a system and method for online advertising using user social information. In general, an advertisement previously selected by a user or by other users belonging to a network constructed using social information and online behavior may be sent to users belonging to the same network in response to a request to serve an advertisement. To serve advertisements using user social information and online behavior, multiple networks that represent the relationship of users may be constructed from social information and online behavior, and these networks may be updated with additional online behavior. In various embodiments, the network may be searched to find one or more advertisements selected by users in the network, and the advertisements may be ranked for instance in order by score of weighted edges in the network connecting the users to a user to be served an advertisement. One or more of the advertisements may then be sent to the user to be served the advertisement from the ranked list of advertisements. In particular, the advertisements may be allocated to web page placements and served to the user for display in the online advertising. As used herein, a web page placement may mean a location on a web page designated for placing an advertisement for display.

As will be seen, the present invention may support many applications for online advertising for online advertising using user social information. For example, online search advertising applications may use the present invention to select a list of advertisements using user social information for web page placements displayed with query results for a user. Or online content applications may use the present invention to select a list of advertisements using user social information for web page placements displayed with content requested by a user. As will be understood, the various block diagrams, flow charts and scenarios described herein are only examples, and there are many other scenarios to which the present invention will apply.

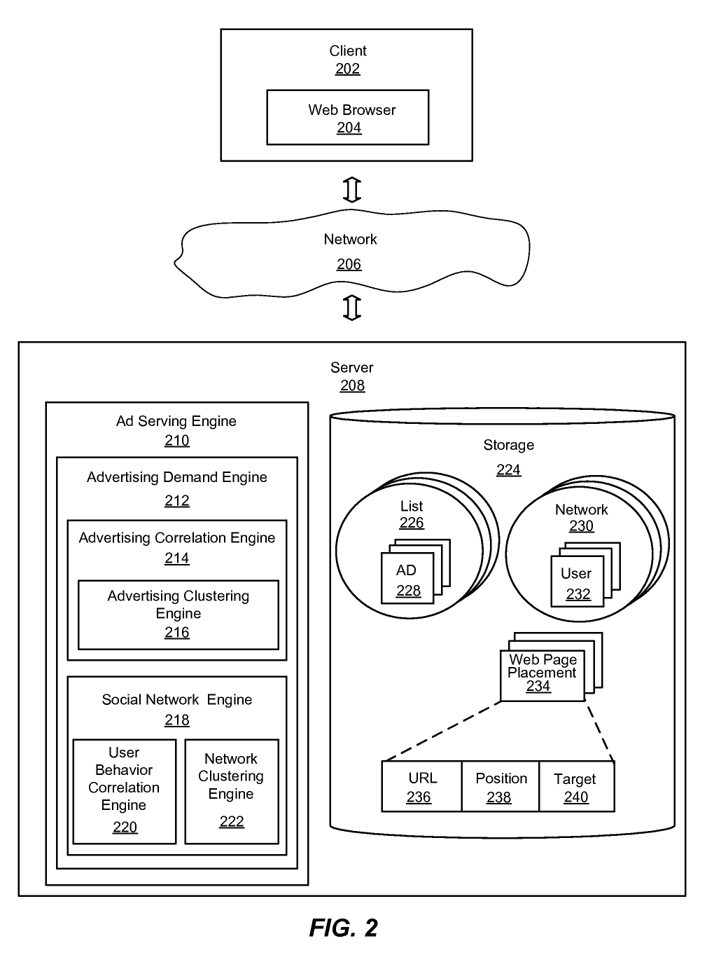

Turning to FIG. 2 of the drawings, there is shown a block diagram generally representing an exemplary architecture of system components for online advertising using user social information. Those skilled in the art will appreciate that the functionality implemented within the blocks illustrated in the diagram may be implemented as separate components or the functionality of several or all of the blocks may be implemented within a single component. For example, the functionality for the social network engine 218 may be included in the same component as the advertising demand engine 212. Or the functionality of the advertisement demand engine 212 may be implemented as a separate component from the advertisement serving engine 210. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a request for content which may be input by a user and for sending the request to a server to obtain the requested content. In general, the web browser 204 may be any type of interpreted or executable software code such as a kernel component, an application program, a script, a linked library, an object with methods, and so forth. In various embodiments, other applications may be used for sending a request for content, including an email application requesting a message from an inbox, an ecommerce application requesting product information, and an online search advertising application requesting search results for a query, and so forth.

The server 208 may be any type of computer system or computing device such as computer system 100 of FIG. 1. In general, the server 208 may provide services for processing requests for content and may include services for providing a list of advertisements to accompany the content requested. In particular, the server 208 may include an advertisement serving engine 210 for serving advertisements, an advertising demand engine 212 for providing a list of one or more advertisements to accompany requested content, an advertising correlation engine 214 for correlating advertisements, and a social network engine 218 for constructing networks of correlated users from social network information and online behavior. The advertising correlation engine 214 may include an advertising clustering engine 216 for clustering advertisements. The social network engine 218 may include a user behavior correlation engine 220 for correlating a user to another user by applying user profile information such as contacts, buddy list and other explicit social network information, and by applying user online behavior such as advertisements selected by users. The social network engine 218 may also include a network clustering engine 222 for merging networks of correlated users. Each of these modules may also be any type of executable software code such as a kernel component, an application program, a linked library, an object with methods, or other type of executable software code.

The server 208 may be operably coupled to a database of information such as storage 224 that may include lists 226 of any type of advertisements 228 and networks 230 of users 232. In an embodiment, an advertisement 228 may be displayed according to a web page placement 234. The web page placement 234 may include a Uniform Resource Locator (URL) 236 for a web page, a position 238 for displaying an advertisement on the web page, and a target ID 240 for referencing a target or group of users that may be defined by a network of characteristics that may match a visitor of the web page. In various embodiments, a target may be defined by demographic information including gender, age, or surfing behavior. The network of users may co-exist with existing segmentation methods including demographic-based in various embodiments.

Those skilled in the art will also appreciate that many of the components of the computer system 100 and the system components for online advertising using user social information illustrated in FIG. 2 may be implemented within a system-on-a-chip architecture including memory, external interfaces, the operating system and advertising serving engine. System-on-a-chip implementations are common for special purpose hand-held devices, such as mobile phones, digital music players, personal digital assistants and the like.

There may be many applications which may use the present invention for online advertising using user social information. For example, online search advertising applications may use the present invention to select a list of advertisements using user social information for web page placements displayed with query results for a user. Or online content applications may use the present invention to select a list of advertisements using user social information for web page placements displayed with content requested by a user. Similarly, email applications may use the present invention to select a list of advertisements using user social information to be displayed with a message from an inbox requested by a user, or ecommerce applications may use the present invention to select a list of advertisements using user social information to be displayed with product information requested by a user. For any of these online applications, a list of advertisements may be selected by the present invention using user social information for display to a user.

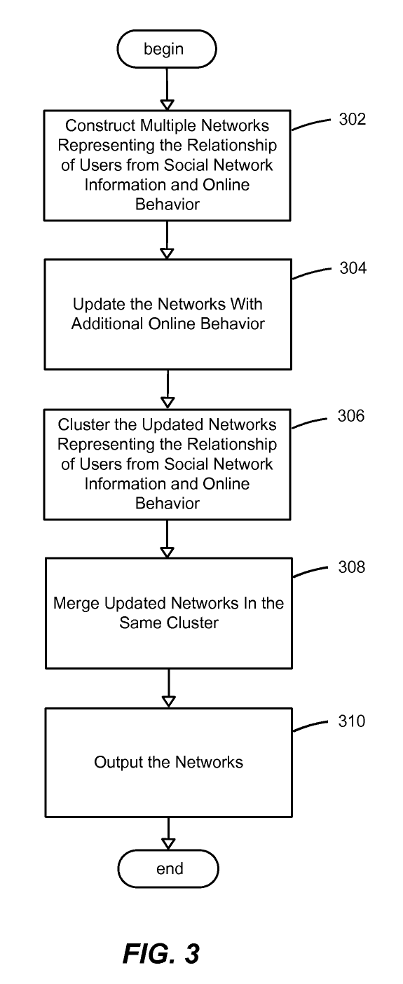

FIG. 3 presents a flowchart for generally representing the steps undertaken in one embodiment for constructing multiple networks representing the relationship of users from social network information and online behavior. At step 302, multiple networks representing the relationship of users may be constructed from social network information and online behavior. In an embodiment, explicit social network information may be available for a user such as a contact list, a buddy list, a declaration of friends. The explicit social network information may be used to build a network graph for a user. In various embodiments, a bidirectional weighted graph may be constructed with edges between a user and other users in the social network. Information from online behavior may then be used to add users to the graph, add edges between users in the graph, and/or change weights assigned to edges between users in the graph. For example, a group of users may browse a particular online photo service frequently. New weighted edges between users of such a group may be added or the weights may be changed for existing edges between users of the group.

At step 304, the multiple networks may be updated with additional information from online behavior. For example, information from online behavior, such as browsing photos in a particular photo service or clicking the same advertisements, may then be used to add users to the graph, add edges between users in the graph, and/or change weights assigned to edges between users in the graph. Machine learning techniques may obtain the correlations between users and pages that they have visited in an embodiment and the connections between two users may be given higher weight if the two users have visited more same or similar web pages.

The updated networks representing the relationship of users from social network information and online behavior may then be clustered at step 306. In an embodiment, clustering of updated networks may be implemented using hierarchical clustering. In other embodiments, clustering of updated networks may be implemented using partitional clustering algorithms. In various embodiments, when a strong correlation exists between the advertisements predicted based on two updated networks, the networks may be clustered together.

Once the updated networks may be clustered, updated networks in the same cluster may be merged at step 308, and then the multiple networks representing the relationship of users may be output at step 310. Many online applications may use the network to apply user social information for online advertising.

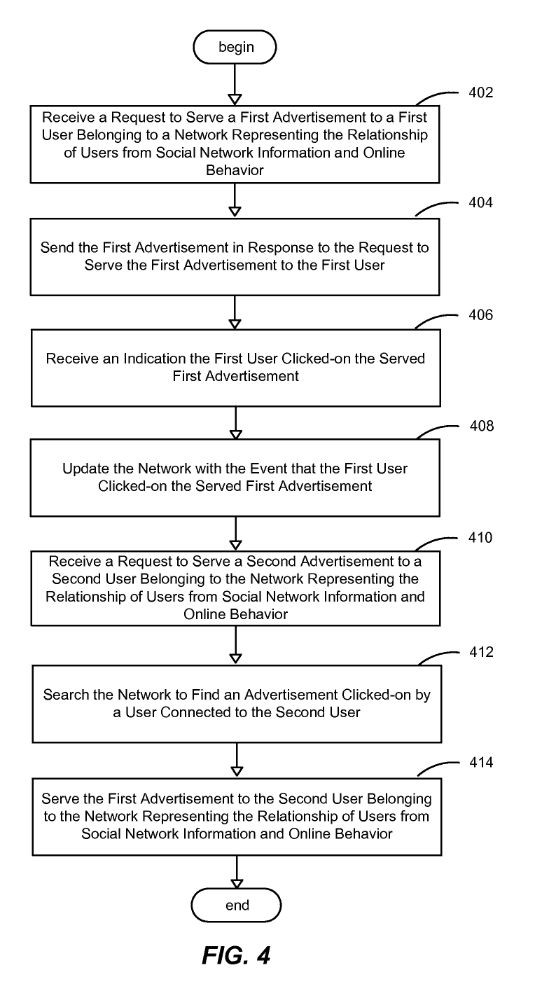

FIG. 4 presents a flowchart for generally representing the steps undertaken in one embodiment for applying user social information to serve an advertisement to other users in online advertising. At step 402, a first request may be received to serve an advertisement to a first user belonging to a network representing the relationship of users from social network information and online behavior. At step 404, a first advertisement may be sent in response to the first request to serve an advertisement to the first user.

At step 406, an indication may be received that the first user clicked on the served first advertisement. At step 408, the event of the first user clicking on the served first advertisement may be applied to update the first user's network representing the relationship of users from social network information and online behavior. When a request may be received to find another advertisement for another user connected to the first user in the same network, the network may be searched and the advertisement clicked-on by the first user may be chosen. At step 410, a second request may be received to serve an advertisement to a second user belonging to the same network representing the relationship of users from social network information and online behavior as the first user. At step 412, the network may be searched to find a user connected from the second user and an advertisement clicked-on by the user. For instance, the second user may be connected to the first user and the first advertisement may be found that was previously clicked-on by the first user. At step 414, the first advertisement may be sent in response to the second request to serve an advertisement to the second user.

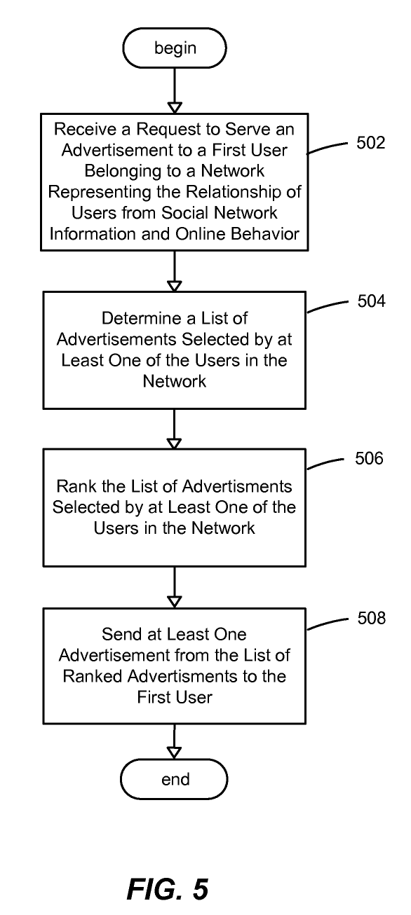

FIG. 5 presents a flowchart for generally representing the steps undertaken in one embodiment for applying user social information to serve multiple advertisements to a user in online advertising. At step 502, a first request may be received to serve an advertisement to a first user belonging to a network representing the relationship of users from social network information and online behavior. At step 504, a list of advertisements selected by other users in the same network may be determined. In an embodiment, a list of advertisements may be chosen that were previously clicked-on by other users who are connected by higher weighted edges to the first user in the network.

Once a list of advertisements may be chosen that were previously clicked-on by users in the network, the list of advertisements previously clicked-on by the other users in the network may be ranked at step 506 in order by the score of the weighted edges connecting the other users to the first user. And at least one advertisement may be sent from the list of ranked advertisements to the first user at step 508.

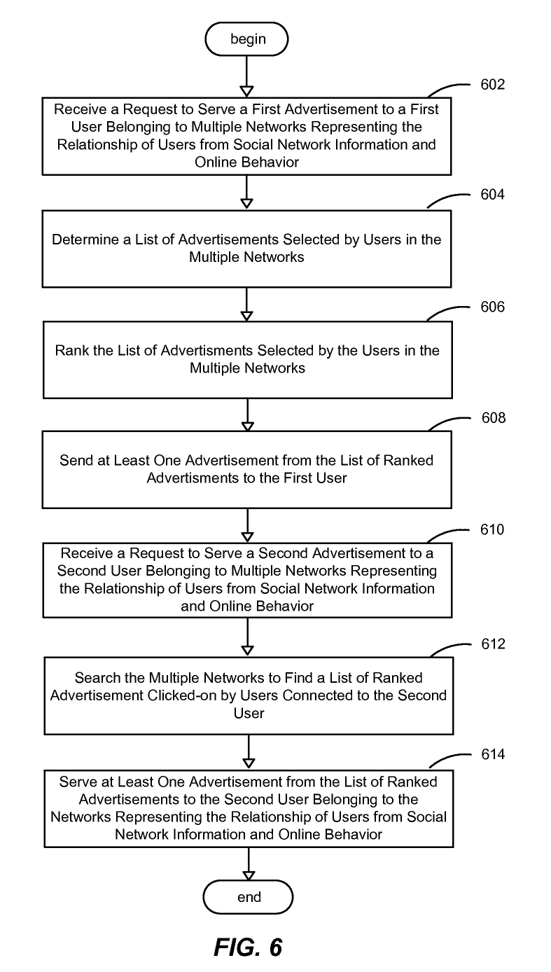

FIG. 6 presents a flowchart for generally representing the steps undertaken in one embodiment for applying user social information to serve multiple advertisements to multiple users in online advertising. At step 602, a first request may be received to serve an advertisement to a first user belonging to multiple networks representing the relationship of users from social network information and online behavior. At step 604, a list of advertisements selected by other users in multiple networks may be determined. In an embodiment, a list of advertisements may be chosen that were previously clicked-on by other users who are connected by weighted edges to the first user in the multiple networks.

Once a list of advertisements may be chosen that were previously clicked-on by other users in the multiple networks, the list of advertisements previously clicked-on by the other users in the multiple networks may be ranked at step 606 in order by the score of the weighted edges connecting the other users to the first user in the multiple networks. And at least one advertisement may be sent from the list of ranked advertisements to the first user at step 608.

At step 610, a request may be received to serve an advertisement to a second user belonging to multiple networks representing the relationship of users from social network information and online behavior. At step 612, the multiple networks may be searched to find a list of ranked advertisements click-on by users connected to the second user. In an embodiment, the second user may be connected to the first user by a weighted edge and the list of ranked advertisements previously clicked-on by the other users in the multiple networks chosen for the first user may also be selected for serving at least one advertisement to the second user. And at step 614, at least one advertisement may be sent from the list of ranked advertisements in response to a second request to serve an advertisement to the second user.

Those skilled in the art will appreciate that the present invention may correlate advertisements and users from social network information and online behavior by an indication of a user's interest in an advertisement other than by the user selecting a link to an advertisement. For instance, in addition to showing interest in an advertisement by selecting a link to an advertisement, a user may mouse over a link to an advertisement or a graphical advertisement to indicate interest. Or conversion rates of impressions of an advertisement may be used. Moreover, different indications of user interest may be combined to generate a user interest score. Such a score could further be weighted by other factors such as revenue potential, delivery objectives, and so forth.

Thus the present invention may serve advertisements using user social information and online behavior. By providing more relevant advertisements to users, the click-through rates of advertisements served to users may increase, and in turn, revenue from online advertising may also enjoy a concomitant increase. Advantageously, the system and method is able to respond to changing user interest in online advertising by tracking user click history and updating the networks of correlated users from social network information and online behavior. Analysis of a user's web browser history may further be used to update the networks. In addition to increasing revenue, serving advertisement of interest to users may also improve the user experience in many online advertising applications. Importantly, the system and method scale well for different types of rich media advertisements, including video advertisements, Internet TV, music advertisements, graphics advertisements, and text advertisements.

As can be seen from the foregoing detailed description, the present invention provides an improved system and method for online advertising using user social information. An advertising demand engine may be provided for selecting advertisements using user social information and online behavior to serve to a user for display. A social network engine may be provided for constructing a plurality of networks of correlated users from social network information and online behavior. These networks may be updated with additional online behavior. An advertisement previously selected by a user or by other users belonging to a network constructed using social information and online behavior may be sent to users belonging to the same network in response to a request to serve an advertisement. Many applications may use the present invention for online advertising using user social information, including online search advertising applications to select a list of advertisements using user social information for web page placements displayed with query results for a user, or online content applications to select a list of advertisements using user social information for web page placements displayed with content requested by a user. As a result, the system and method provide significant advantages and benefits needed in contemporary computing, and more particularly in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for online advertising, comprising:
an advertising demand engine for selecting one or more advertisements using user social information and online behavior to display to a user; and
a storage operably coupled to the advertising demand engine for storing a plurality of networks of a plurality of users, each network constructed from social information and online behavior of at least some of the plurality of users.

2. The system of claim 1 further comprising an advertising correlation engine operably coupled to the advertising demand engine for correlating an advertisement with a previously served advertisement for display to the user.

3. The system of claim 2 further comprising an advertising clustering engine operably coupled to the advertising correlation engine for clustering a plurality of correlated advertisements.

4. The system of claim 1 further comprising a social network engine operably coupled to the advertising demand engine for constructing a plurality of networks of correlated users from social network information and online behavior to serve the one or more advertisements to the user for display in online advertising.

5. A computer-readable medium having computer-executable components comprising the system of claim 1.

6. A computer-implemented method for online advertising, comprising:
receiving a request to serve a first advertisement to a first user belonging to a network constructed from social information and online behavior of a plurality of users;
sending the first advertisement in response to the request to serve the first advertisement to the first user belonging to the network constructed from social information and online behavior of the plurality of users;
receiving a request to serve a second advertisement to a second user belonging to the network constructed from social information and online behavior of the plurality of users; and
serving the first advertisement in response to the request to serve the second advertisement to the second user belonging to the network constructed from social information and online behavior of the plurality of users for display to the second user.

7. The method of claim 6 further comprising receiving an indication that the first user selected the first advertisement.

8. The method of claim 7 further comprising updating the network constructed from social information and online behavior of the plurality of users in response to receiving the indication that the first user selected the first advertisement.

9. The method of claim 8 further comprising searching the network constructed from social information and online behavior of the plurality of users to find an advertisement in response to receiving the request to serve the second advertisement to the second user belonging to the network constructed from social information and online behavior of the plurality of users.

10. The method of claim 9 further comprising selecting the first advertisement found by searching the network constructed from social information and online behavior of the plurality of users.

11. A computer-readable medium having computer-executable instructions for performing the method of claim 6.

12. A computer-implemented method for online advertising, comprising:
receiving a request to serve a first advertisement to a first user belonging to at least one network constructed from social information and online behavior of a plurality of users;
determining a list of advertisements selected by at least one user in the at least one network constructed from social information and online behavior of the plurality of users;
ranking the list of advertisements selected by at least one user in the at least one network constructed from social information and online behavior of the plurality of users; and
sending at least one advertisement from the list of ranked advertisement for display to the first user.

13. The method of claim 12 wherein determining the list of advertisements selected by at least one user in the at least one network constructed from social information and online behavior of the plurality of users comprises choosing a list of advertisements previously clicked-on by the at least one user connected by weighted edges to the first user in one network.

14. The method of claim 12 wherein determining the list of advertisements selected by at least one user in the at least one network constructed from social information and online behavior of the plurality of users comprises choosing a list of advertisements previously clicked-on by at least one user connected by weighted edges to the first user in a plurality of networks.

15. The method of claim 12 wherein ranking the list of advertisements selected by the at least one user in the at least one network constructed from social information and online behavior of the plurality of users comprises ranking the list of advertisements previously clicked-on by the at least one user in the at least one network in order by score of weighted edges connecting the at least one user to the first user.

16. The method of claim 12 wherein ranking the list of advertisements selected by the at least one user in the at least one network constructed from social information and online behavior of the plurality of users comprises ranking the list of advertisements previously clicked-on by the at least one user in a plurality of network in order by score of weighted edges connecting the at least one user to the first user.

17. The method of claim 12 further comprising receiving an indication that the first user selected the at least one advertisement.

18. The method of claim 12 further comprising updating the network constructed from social information and online behavior of the plurality of users in response to receiving the indication that the first user selected the at list one advertisement.

19. The method of claim 12 further comprising sending the at least one advertisement from the list of ranked advertisements to a second user for display in response to a second request to serve an advertisement to the second user.

20. A computer-readable medium having computer-executable instructions for performing the method of claim 12.
